(19) United States
(12) Patent Application Publication
(10) Pub. No.: US 2026/0249478 A1
(43) Pub. Date: Aug. 27, 2026

(54) ROBOTIC SYSTEM FOR CONDUCTING ITEM-SPECIFIC IN-PROCESS INSPECTION

(71) Applicant: ABB SCHWEIZ AG, Baden (CH)

(72) Inventors: Matt Simkins, Richmond, VA (US); Sriharsha Vardhan Thimmareddy, Richmond, VA (US)

(21) Appl. No.: 19/649,627

(22) Filed: Apr. 16, 2026

Related U.S. Application Data
(63) Continuation of application No. PCT/US2023/077215, filed on Oct. 18, 2023.

(51) Int. Cl. B25J 9/16; B25J 19/02

(52) U.S. Cl. CPC B25J 9/1697; B25J 19/023

(57) ABSTRACT

A robotic system for conducting item-specific in-process inspection is provided. The system performs a task, such as a task relating to a supply chain process. The system includes a camera configured to capture media content, and a processor. The processor detects a package (or item), and causes the camera to capture media content of the package including. The processor compares the media content of the package to at least one specification defined for the package to generate a comparison. The processor determines, based on the comparison, whether the package as represented by the media content does not conform to the at least one specification defined for the package. If the package does not conform to the at least one specification, the processor performs an action associated with the package, such as remove the package, replace the package, not select the package, or transmit an alert.

### CROSS REFERENCE TO RELATED APPLICATION

This patent application is a continuation of International Patent Application No. PCT/US2023/077215, entitled “Robotic System for Conducting Item-Specific In-Process Inspection,” filed October 18, 2023, which application is incorporated herein by reference in its entirety.

### FIELD OF THE TECHNOLOGY

At least some embodiments disclosed herein relate to robotic system technologies, inspection technologies, sensor technologies, automation technologies, logistics technologies, and more particularly, but not limited to, a robotic system for conducting item-specific in-process inspection.

### BACKGROUND

In today’s society, technological advancements in order fulfillment, logistics, and operations management capabilities have led to the increased adoption of e-commerce by consumers for various types of product and services. This trend of increased adoption has been widely known and acknowledged, and is projected to increase even further as technologies continue to improve. Based on at least the foregoing, distribution centers for distributing products not only have ever-increasing inventories of products, but also increasing diversity of products. Different types of products often require different packaging which often require different labeling, different packaging form factors, different volumes, and other different characteristics. Moreover, the expected package condition for each type of product may also vary. For example, a manufacturer may opt to store inexpensive toy products in a fulfillment center, which may have comparatively lower standards for labeling and package integrity than compared to other types of products. Since the toys may be inexpensive, robust, and non-critical, a certain threshold level of box damage or contamination may be acceptable, and labeling requirements may be less critical than for other products. On the other hand, other products, such as food items or fragile items, may have significantly higher standards relating to labelling, acceptable package damage, or contamination. For example, suppliers of food items, hazardous materials, or pharmaceuticals may be willing to pay for heightened package inspection and scrap costs due to the nature and characteristics of such products. In the event items must be removed from circulation, it may be preferable to remove such items as early as possible in the supply chain to avoid adding unneeded costs downstream in the supply chain.

Current inspection means involve using factory and operations personnel to manually inspect products at various stages of the supply chain using periodic inspection that is not only costly, but can also be hazardous depending on where the inspections take place and the types of products being inspected. While inspections personnel are often capable of conducting inspections, with ever-increasing types of products and volumes of products being handled through the supply chain, conducting effective and accurate inspections are now significantly more difficult. To alleviate such concerns, more personnel can be trained, however, doing so greatly increases costs and may result in different levels of training for each inspection personnel, thereby leading to suboptimal inspection outcomes. While current inspection techniques provide various benefits, such inspection techniques and technologies may be enhanced to provide improved product monitoring and condition-detection capabilities, reduced expenses, superior inspection outcomes, and greater supply chain efficiency.

### SUMMARY

A system for conducting item-specific in-process inspection is provided. The system can include a robotic device configured to perform any number of tasks, such as tasks relating to a particular stage in a supply chain. In certain embodiments, the system can also include one or more cameras configured to capture media content, and one or more processors configured to perform various operations. In certain embodiments, a processor of the system can be configured to cause the robotic device to perform one or more tasks during the stage in the supply chain. Such tasks, for example, can include, but are not limited to, palletizing, depalletizing, induction, sorting, item picking or packing, storage and/or retrieval of packages and/or items, any other tasks, or a combination thereof. In certain embodiments, the processor can detect, by utilizing the one or more cameras and as part of a task, one or more packages, one or more items (e.g., a product), or a combination thereof. In certain embodiments, the processor can cause the one or more cameras to capture media content of the one or more packages, the one or more items, or a combination thereof. In certain embodiments, the processor can compare the media content of the one or more packages, the one or more items, or a combination thereof, to specifications defined for the one or more packages, the one or more items, or a combination thereof, to generate a comparison. In certain embodiments, the processor can perform actions associated with the one or more packages, the one or more items, or a combination thereof, if the comparison indicates that the one or more packages, the one or more items, or a combination thereof, as represented by the media content does not conform to the specifications defined for the one or more packages, the one or more items, or a combination thereof. For example, such actions may include, but are not limited to, removing the package and/or item, replacing the package and/or item, adjusting and/or modifying packages, adjusting and/or modifying items to be placed in packages, performing over labeling, repacking and/or repackaging items, adding additional packaging to existing packaging and/or items, adding tape or other protective and/or adhesive material to further secure the packaging and/or items, generating an alert, or a combination thereof.

In certain embodiments, the robotic device further can include a gripper device that is configured to secure a package to the robotic device. In certain embodiments, a processor of the system can be further configured to cause the gripper device to secure to a package and/or item to the robotic device after the package and/or item is detected. In certain embodiments, the processor can be further configured to cause the gripper device to release the package and/or item from the robotic device if the comparison indicates that the package and/or item as represented by the media content conforms to the at least one specification defined for the packages and/or items. In certain embodiments, the processor can be further be configured to identify the package and/or item based on the media content. In certain embodiments, the system can further include one or more sensors that can be configured to acquire sensor data associated with the package and/or item, provide the sensor data to the processor, and generate the comparison using the sensor data. In certain embodiments, the system can further include one or more memory devices configured to store specifications for the package and/or item, and store the comparison generated based on comparing the media content to the specifications.

In certain embodiments, the processor can further be configured to cause the robotic device to adjust an orientation and/or position of the package and/or item, and cause the one or more cameras to capture the media content of the package and/or item while in the orientation and/or position. In certain embodiments, the processor can be further configured to modify the specifications for the package and/or item to generate modified specifications. In certain embodiments, the processor can be configured to compare the media content of the package and/or item to the modified specifications defined for the package and/or item. In certain embodiments, the processor can be further configured to detect, by utilizing the one or more cameras and as part of the task being performed, another package and/or another item. In certain embodiments, the processor can be configured to cause the one or more cameras to capture other media content of the other package and/or other item, and compare the media content of the other package and/or other item to different specifications defined for the one other package and/or another item. In certain embodiments, the processor can be further configured to perform one or more actions associated with the package and/or item if the comparison indicates that the package and/or item as represented by the media content does not conform to the specifications defined for the package and/or item. In certain embodiments, the actions can include outputting an alert indicating that the package does not conform to the specifications defined for the package, removing the package, modifying the package and/or item, attaching a label indicating nonconformity with a specification(s) onto the package and/or item, and/or replacing the package with another package conforming to the specifications.

In certain embodiments, a method for conducting item-specific in-process inspection is provided. In certain embodiments, the method can include performing, by utilizing a processor of a robotic system, a task during a stage in a supply chain. In certain embodiments, the method can include causing, as part of the task and by utilizing the processor, one or more cameras to capture media content of a package and/or item. In certain embodiments, the method can include identifying, based on the media content and by utilizing the processor, the package and/or item. In certain embodiments, the method can include comparing, by utilizing the processor, the media content of the package and/or item to specifications defined for the package and/or item to generate a comparison. In certain embodiments, the method can include performing, by utilizing the processor, one or more actions associated with the package and/or item if the comparison indicates that the package and/or item as represented by the media content does not conform to the specifications defined for the package and/or item.

In certain embodiments, the method can include activating a gripper device of the robotic system to secure the package and/or item to the robotic system. In certain embodiments, the method can include adjusting, by utilizing the gripper device, at least one position of the package and/or item, at least one orientation of the package and/or item, or a combination thereof. In certain embodiments, the method can include capturing, by utilizing the camera device, the media content of the package and/or item in the at least one position, in the at least one orientation, or a combination thereof. In certain embodiments, the one or more actions that can be performed can include outputting an alert indicating that the package and/or item does not conform to the specifications defined for the package and/or item, removing the package and/or item, and replacing the package and/or item with another package conforming to the specifications, or a combination thereof. In certain embodiments, the method can include setting the specifications for the package and/or item based on a type of the package and/or item, based on a quality standard, based on a labeling standard, or a combination thereof. In certain embodiments, the package can be a primary package, a secondary package, or a combination thereof. In certain embodiments, the specifications can include a labeling specification, a contamination specification, a label location, a package damage specification, an expiration date, a color specification, a print quality specification, a packaging specification, an item specification for an item, or a combination thereof. In certain embodiments, the method can include capturing sensor data from at least one sensor configured to capture the sensor data associated with the package and/or item, and generating the comparison using the media content and the sensor data.

In certain embodiments, a robotic device for item-specific in-process inspection is provided. In certain embodiments, the robotic device can include one or more cameras configured to capture media content, and one or more processors configured to perform a variety of operations. In certain embodiments, a processor of the robotic device can be configured to perform a task during a stage in a supply chain. In certain embodiments, the processor can be configured to cause, as part of the task, the one or more cameras to capture media content of a package and/or item. In certain embodiments, the processor can be configured to identify, based on the media content, the package and/or item. In certain embodiments, the processor can be configured to compare the media content of the package and/or item to specifications defined for the package and/or item to generate a comparison. In certain embodiments, the processor can be configured to perform one or more actions associated with the package and/or item if the comparison indicates that the package and/or item, as represented by the media content, does not conform to the specifications defined for the package and/or item.

### BRIEF DESCRIPTION OF THE DRAWINGS

The embodiments of the present disclosure are illustrated by way of example and not limited by the figures of the accompanying drawings in which like references indicate similar elements. Embodiments of the present disclosure will be described in even greater detail below based on the exemplary figures. The present disclosure is not limited to the exemplary embodiments. All features described and/or illustrated herein can be used alone or combined in different combinations in embodiments of the present disclosure. The features of various embodiments of the present disclosure will become apparent by reading the following detailed description with reference to the attached drawings which illustrate the following:

FIG. 1 is an exemplary schematic diagram illustrating a robotic system configured to conduct item-specific in-process inspection according to embodiments of the present disclosure.

FIG. 2 is an exemplary schematic diagram illustrating a robotic system configured to conduct item-specific in-process inspection according to additional embodiments of the present disclosure.

FIG. 3 is an exemplary schematic diagram illustrating various components of a robotic device of a robotic system for conducting item-specific in-process inspection according to embodiments of the present disclosure.

FIG. 4 is an exemplary perspective view of a primary product packaging that can be inspected by a robotic system according to embodiments of the present disclosure.

FIG. 5 is an exemplary front perspective view secondary product packaging that can be inspected by a robotic system according to embodiments of the present disclosure.

FIG. 6 is an exemplary system illustrating multiple robotic systems configured to conduct item-specific in-process inspection and share information via a communications network according to embodiments of the present disclosure.

FIG. 7 illustrates an exemplary method for conducting item-specific in-process inspection according to embodiments of the present disclosure.

FIG. 8 illustrates a schematic diagram of a machine in the form of a computer system within which a set of instructions, when executed, can cause the machine to conduct item-specific in-process inspection according to embodiments of the present disclosure.

### DETAILED DESCRIPTION

The present disclosure describes various embodiments of a robotic system and accompanying devices for conducting item-specific in-process inspection. More specifically, the present disclosure provides for a robotic system that utilizes cameras and/or other types of sensors to capture information, such as during performance of a task during a stage of a supply chain, to inspect products to determine if the products do not conform to defined specifications for the products (and/or packaging). For example, in logistical and warehouse settings, the inspection conducted by the robotic system can occur as part of any number of robotic tasks, such as, but not limited to, palletizing, depalletizing, induction, sorting, item picking, item packing, storage and/or retrieval of packages and/or items, and/or other robotic tasks to assist in facilitating continuous process flow. In certain embodiments, the robotic system can leverage existing cameras and/or sensor devices of a robotic device of the robotic system to avoid having to incorporate additional hardware into the robotic system. For example, cameras that may be utilized for object localization or barcode reading can also be utilized to conduct inspections according to the embodiments of the present disclosure. In certain embodiments, the cameras and/or sensor devices can capture media content and/or sensor data of products, and the robotic system can compare the product as represented by the media content and/or sensor data to defined specifications for the product.

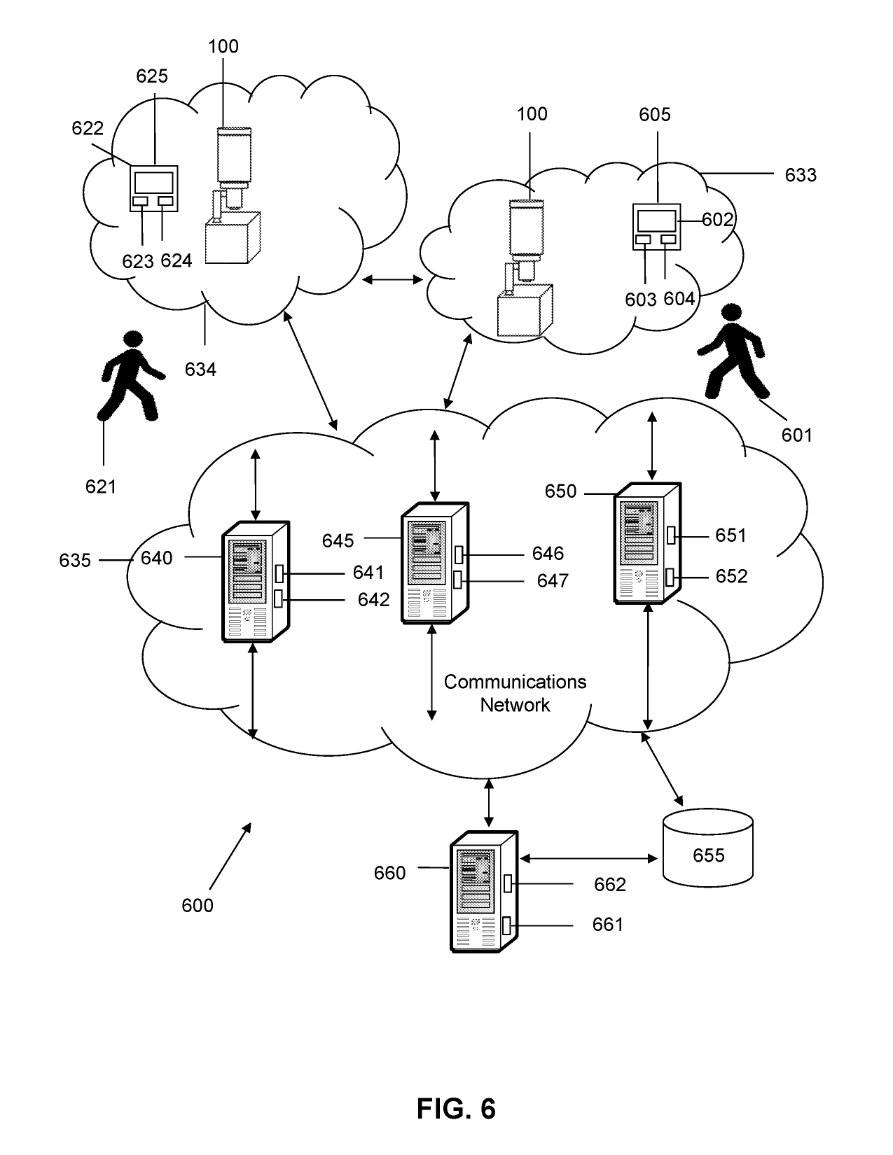

If the product does not conform to one or more specifications based on the comparison, the robotic system can perform an action, such as, but not limited to, remove the product from its current location to another location, replace the product with a conforming product, modifying the product to conform to the specifications, not picking the product, and/or perform other actions. The robotic system is capable of detecting defective packaging early in the supply chain, and, as a result, significant costs can be saved by conducting effective inspections before the products moves too far down the supply chain. For example, if a defective product (or package) is removed during palletizing, the added cost of shipping that package, storing the package, and retrieving the package before detecting the defect can be avoided. In certain embodiments, the robotic system can be configured to pick up a product and manipulate the product (e.g., rotate, change position, push, etc.) and position the product in front of a camera and/or sensor and capture media content and/or sensor data from all orientations, angles, positions of the package to capture additional information associated with the package. In certain embodiments, the robotic system can include integrated cameras (e.g., a hand-eye camera) and/or sensors that can be collocated with a gripper device of the robotic system to perform the inspections. In certain scenarios, hand-eye implementations can be helpful for situations where the gripper device of the robotic system can occlude a portion of the package surface and where the package media content needs to be captured immediately before or after securing the package using the gripper device. In certain embodiments, the inspection and comparison to specifications can be conducted at the robotic system itself locally, however, in certain embodiments, the media content can be conducted remotely by transmitting the media content to a system (e.g., system 600 in FIG. 6) for further processing and analysis. In certain embodiments, any types of specifications can be utilized (e.g., quality levels, labeling standards, etc.) and can be modified as desired at any time.

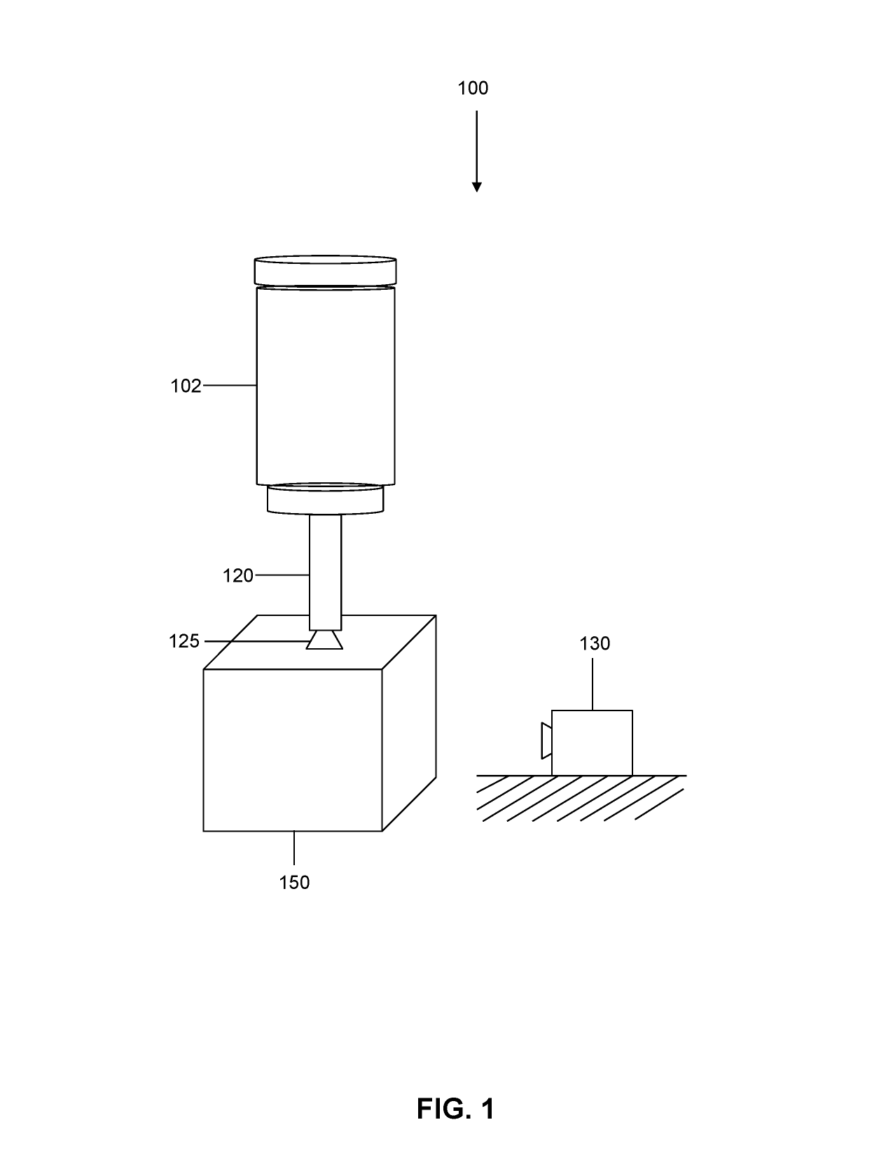

Referring now to FIG. 1, a schematic diagram illustrating a robotic system 100 configured to conduct item-specific in-process inspection according to embodiments of the present disclosure is provided. In certain embodiments, the robotic system 100 can include be utilized to perform any number of tasks, such as, but not limited to, forming, labeling, creating, distributing, sorting, delivering, palletizing, depalletizing, induction, item picking or packing, placing and/or removing items, adjusting items and/or packages, and/or performing any other actions associated with a supply chain. In certain embodiments, the robotic system 100 can include a robotic device 102, a gripper device 120, a gripper portion 125, a camera 130, and a package 150. In certain embodiments, the robotic device 102 can be any type of robotic device 102 and/or component, such as, but not limited to, a robotic arm, a robotic tool, a robotic manipulator, a robotic end effector, a controller, a locomotive device, any other robotic component or device, or a combination thereof. In certain embodiments, the robotic device 102 can be configured to control, manipulate, rotate, move, and/or adjust any type of component attached to the robotic device 102, such as the gripper device 120 and/or the gripper end effector 125. In certain embodiments, the robotic system 100 can include any number of gripper devices 120, which can be configured to move forwards, backwards, side to side, or a combination thereof. In certain embodiments, the gripper device 120 can be configured to grip onto, latch onto, grab, secure, and/or otherwise attach to a package 150, an item contained in the package 150, or a combination thereof. In certain embodiments, when the gripper device receives a signal from the robotic device 102, the gripper device 120 can either grab onto a package 150 or release the package 150. In certain embodiments, the gripper end effector 125 can be a component of the gripper device 120 that can be attached to and/or grab a package 150, such as during a stage of a supply chain. In certain embodiments, the gripper end effector 125 can be a suction cup-style attachment, a claw capable of closing and opening, a component with an adhesive, a component with any type of grabbing tool, or a combination thereof.

In certain embodiments, the robotic system 100 can include a camera 130, which may be separate from the robotic device 102, as shown in FIG. 1. In certain embodiments, the camera 130 can be any type of camera and can be configured to capture media content. Such media content can include video content, image content, audio content, any type of content, or a combination thereof. In certain embodiments, the camera 130 can include a processor (and/or microprocessor), a memory, a communication module, any other components or a combination thereof. In certain embodiments, the camera 130 can be controlled by the robotic system 100 and/or robotic device 102. In certain embodiments, the camera 130 can be triggered to operate based on a package coming within view of a viewing range of the camera 130 lens, based on a signal from the robotic device 102 and/or system 100, based on periodic intervals, and/or other means for triggering activation of the camera 130. In certain embodiments, the robotic device 102 can be configured to pick up and/or attached to a package and position the package within the viewing range of the camera 130, as shown in FIG. 1. In certain embodiments, the camera 130 can capture media content of the package from all angles, orientations, and/or positions. For example, the robotic device 102 can manipulate the package 150 in front of the camera 130 viewing range such that the camera can capture media content of the package 150 from all angles, orientations, and/or positions. In certain embodiments, the camera 130 operation can be triggered based on a motion sensor detecting presence of a package within the viewing range of the lens of the camera 130.

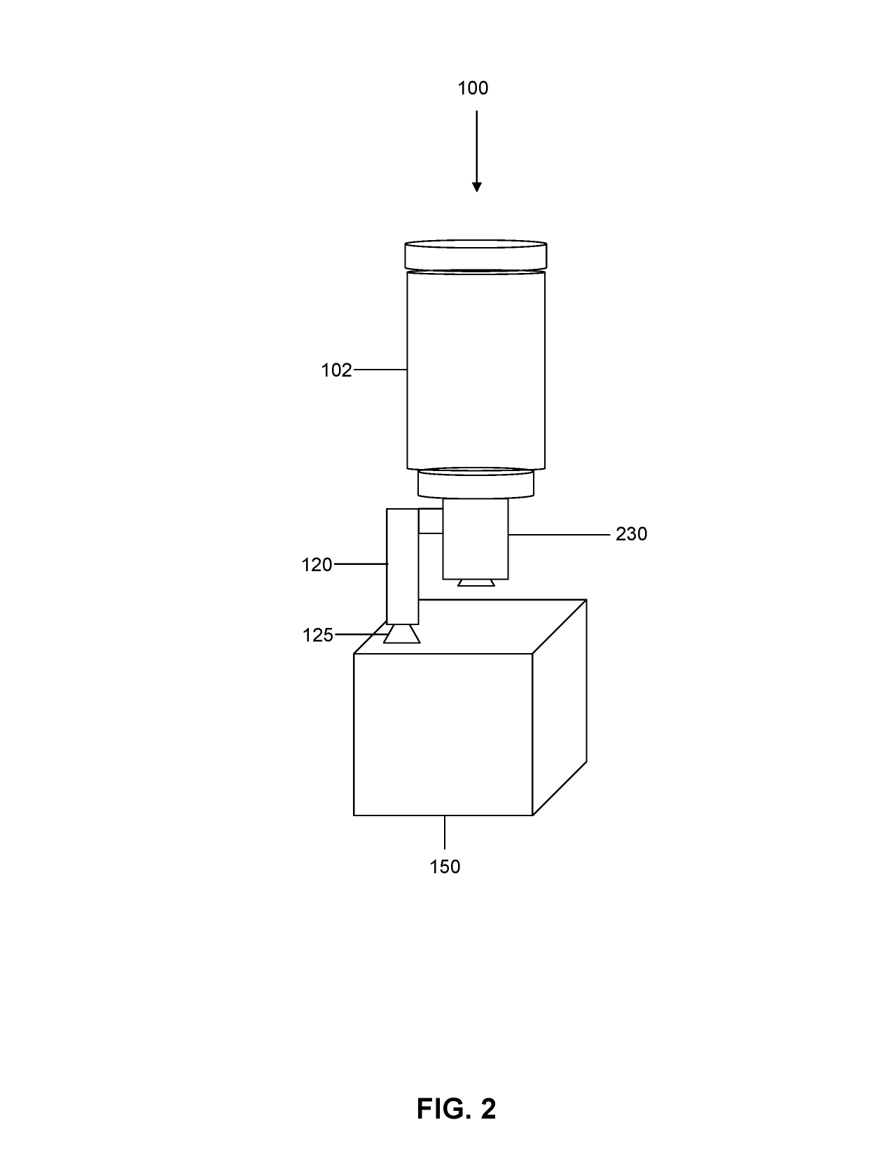

Referring now also to FIG. 2, an exemplary schematic diagram illustrating another embodiment of a robotic system 100 configured to conduct item-specific in-process inspection according to additional embodiments of the present disclosure. In certain embodiments, the robotic system 100 of FIG. 2 can include any of the components of the robotic system of FIG. 1. In certain embodiments, the embodiment of the robotic system 100 of FIG. 2 can have the camera 230 integrated into the robotic device 102 instead of being separate from the robotic device 102. In certain embodiments, the robotic device 102 can include a camera 230, a gripper device 120 attachable to the camera 230, and a gripper end effector 125. In certain embodiments, the camera 230 can be attached to a bottom portion of the robotic device 102, as shown in FIG. 2. In certain embodiments, the camera(s) 230 can be mounted onto and/or placed in proximity to any portion of the robotic device 102, such as, but not limited to, a linkage of the robotic device 102, an arm of the robotic device 102, any surface of the robotic device 102, or a combination thereof. In certain embodiments, the camera(s) 230 can be placed in any position as long as the package 150 is within viewing range of the camera(s) 230. In certain embodiments, the camera 230 can be configured to face downwards so that when the robotic device 102 is in the process of grabbing onto or securing onto a package 150, the camera 230 can capture media content of the top surface of the package 150. In certain embodiments, the camera 230 can be configured to face in other directions. In certain embodiments, the gripper device 120 can be figured to rotate around the body of the camera 230 and can be attached to the body of the camera 230. In certain embodiments, the gripper device 120 can adjust the position, orientation, and/or angles of the package 150 so that the camera 230 can capture media content of all sides of the package 150.

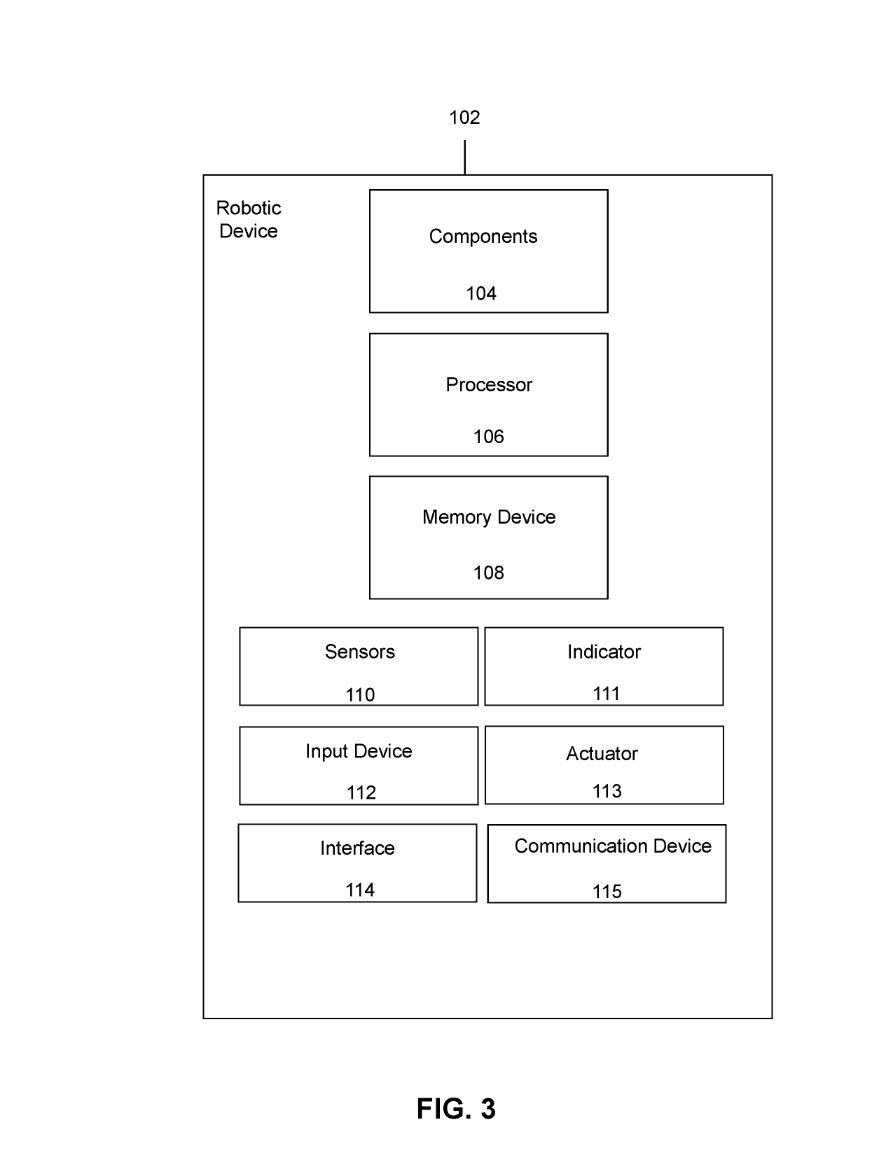

Referring now also to FIG. 3, a schematic diagram illustrating various components of a robotic device 102 of a robotic system 100 for conducting item-specific in-process inspection according to embodiments of the present disclosure is provided. In certain embodiments, the robotic device 102 can be located in an environment, such as a factory or other portion of a supply chain. In certain embodiments, portions of the robotic system 100 can be located at the location of the packages and/or items being inspected and other portions of the robotic system 100 can be located remotely (e.g., an off-site server or computing device). In certain embodiments, the robotic system 100 can be entirely located at the location of the packages and/or items being inspected. In certain embodiments, the robotic device 102 can include any number of components 104, which may include, but are not limited to, robotic arms, a robotic tool, a robotic manipulator, a robotic end effector, a controller, a locomotive device, any other robotic component or device, or a combination thereof. In certain embodiments, the robotic device 102 can include any components 104, processors 106, memory devices 108, sensors 110, indicators 111, input devices 112, actuators 113, interfaces 114, communication devices 115, any other components or a combination thereof. In certain embodiments, the processor 106 can be configured to receive data, transmit data, receive media content from cameras 130, 230, process data and/or content, perform tasks, transmit media content from cameras 130, 230, compare media content to specifications defined for packages and/or items, perform any other operations of the present disclosure, or a combination thereof. In certain embodiments, the memory device 108 can be configured to store instructions for execution by the processor 106, store specifications for packages and/or items, store comparisons between media content and specifications, store any information generated by the robotic system 100 and/or system 600. In certain embodiments, the memory device 108 can be any type of memory device including, but not limited to, non-volatile memory, volatile memory, other types of memory, or a combination thereof. In certain embodiments, the sensors 110 can include, but are not limited to, cameras, accelerometers, motion sensors, acoustic/audio sensors, pressure sensors, temperature sensors, light sensors, gyroscopes, chemical sensors, any type of sensors, or a combination thereof. In certain embodiments, the sensors 110 can be affixed directly to the robotic device 102, and/or may be positioned in proximity to the robotic device 102. In certain embodiments, the sensors 110 can be configured to capture media content and detect and/or identify motion, packages and/or items within packages, colors, labels, temperature, pressure, orientation, damage, creases, expiration dates, contamination, text, images, objects, and/or any measurable information. In certain embodiments, sensor data can include, but is not limited to, media content, temperature data, pressure data, humidity data, color data, pixel data, orientation data, damage data, date data, any type of sensor data, or a combination thereof.

In certain embodiments, the sensor data can be compared to baseline data for a particular specification for a package and/or item and may be utilized to trigger output of alerts and/or initiating of actions, such as to replace a package, remove a package, correct or rectify a package, or a combination thereof. In certain embodiments, the processor 106 can be a combination of software, hardware, or a combination thereof, and may be utilized to execute instructions from the memory device 108. The processor 106 can also be configured to analyze sensor data to determine whether a condition exists (e.g., the package does not conform to one or more specifications) and can store sensor data and/or determinations in the memory device 108. In certain embodiments, the processor 106 can provide sensor data and determinations and/or analyses to any component of the robotic system 100, and/or the system 600.

In certain embodiments, the memory device 108 can be configured to store sensor data, determinations relating to whether a package and/or item conforms to specifications or not, alerts, baseline sensor data (e.g., a baseline relating to how a label should appear, how text should appear, how items should appear, whether contaminants exist, whether a certain color exists, any other sensor data), any other information, or a combination thereof. In certain embodiments, the indicator 111 can be a device that can be configured to output an alert (e.g., when a package does not conform to specifications or the package does not conform to a threshold deviation from an established specification), indicate power levels of the robotic device 102, provide an indication of a task being performed by the robotic system 100, any other information described in the present disclosure, or a combination thereof. In certain embodiments, the interface 114 can be a user interface, a touchscreen, a screen with input devices (e.g., buttons), a display, or other interface to enable a user to perceive alerts, sensor data, information associated with actions to replace, remove, or rectify packages, packages detected, whether a package conforms to specifications or not, any other information described in the present disclosure, or a combination thereof. In certain embodiments, the indicator 111 (or output devices) can be any type of indicator, such as, but not limited to, lighting devices (e.g., LEDs), audio devices (e.g., speaker or microphone), haptic devices, vibration devices, information screens, any other types of indicator devices, or a combination thereof. In certain embodiments, the input device 112 can be a button or other input device that may be configured to activate or deactivate the sensor device 110 and/or robotic system 100, and/or perform any actions with respect to the robotic system 100. In certain embodiments, the actuator 113 can be any type of actuator that may be configured to provide or produce motion for moving or controlling a device or part of a device to cause an action. For example, the actuator 234 can be a mechanism by which the robotic device 102 is capable of actuating the gripper device 120 to secure the gripper end effector 125 to a package 150. As another example, the actuator 113 can activate any components capable of motion, such as robotic device 102 components.

In certain embodiments, the robotic device 102 can also include any number of communication devices 115. Such communications devices 115 can include, but are not limited to, antennas, communication chips, cellular devices, wireless devices (including wireless interfaces), gateways, communication interfaces, any type of communication device or a combination thereof. In certain embodiments, the communication devices can be IoT, Bluetooth, Zigbee, Z-wave, Wireless HART, cellular, LoRA, NB-IoT, etc., or any combination thereof. In certain embodiments, the communications devices 115 can communicate via wired (e.g., Ethernet), wireless, or a combination of wired and wireless communication. In certain embodiments, the communication devices 115 can receive or transmit sensor data, any data of the present disclosure, or a combination thereof, to the robotic system 100, the system 600, other devices and/or systems, or a combination thereof.

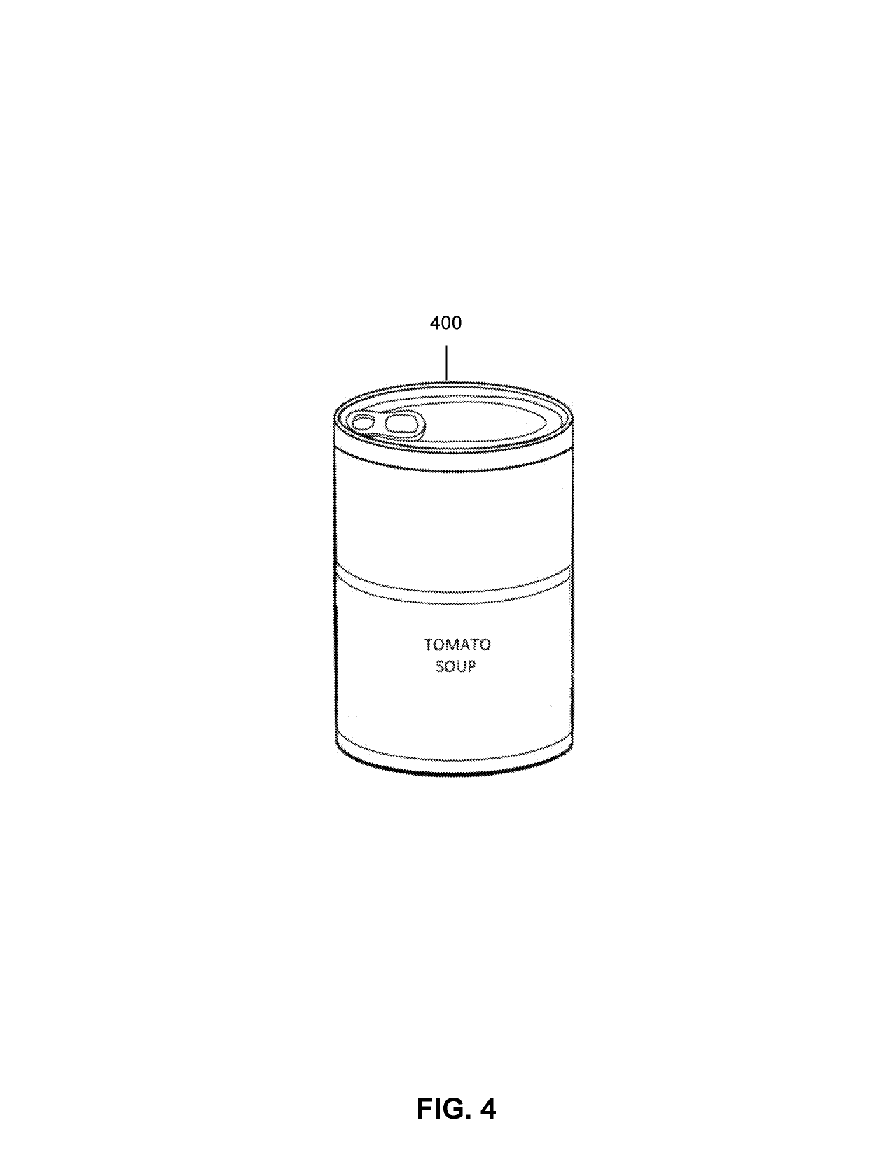

Referring now also to FIGS. 4, an exemplary perspective view of a primary product packaging 400 (or package) that can be inspected by a robotic system 100 is shown. In the example in FIG. 4, the packaging 400 is a can including labeling for tomato soup (or other item) that can be contained within the packaging 400. In certain embodiments, the robotic system 100 can be performing a task (e.g., filling the can with tomato soup or placing the filled in can on a conveyor belt, or performing other actions) and during the task (or at other desired times), can cause a robotic device 102 to secure (e.g., grab, suction, lift, push, etc.) onto the packaging 400. The robotic system 100 can activate a camera 130, 230 of the robotic system 100 to capture media content of the packaging 400. The media content can be provided to the processor 106 of the robotic system 100 for analysis and the processor 106 can compare the packaging 400 as represented by the media content to the specifications that are established and/or defined for the particular type of package. For example, the specifications can indicate a specific color (or range, tones, intensity of colors), specific required labels, specific amounts of acceptable damage or creases for the type of package, a certain expiration date, a print quality level, a contamination level (e.g., acceptable amount and/or type of stains), an acceptable amount of any other criteria, or a combination thereof. In certain embodiments, the specifications can also include media content (e.g., video of the package, image of the package, a text description of the package, any other type of media content, or a combination thereof) of a representative package conforming to the defined specifications that can serve as the basis for the comparison with the captured media content (and/or sensor data captured from sensors). In the event that the comparison indicates nonconformance with one or more specifications (e.g., there is not a direct conformity or the packaging deviates beyond a threshold range of acceptability for a particular feature (e.g., size, color, label type, label size, font type, etc.), the processor 106 can cause the robotic device 102 to perform an action, such as remove the packaging 400 from its current location and replace it with a packaging 400 that conforms to the specification, transfer the nonconforming packaging 400 to a designated area, correct and/or modifying the packaging 400 to conform to the specifications, perform any other actions, or a combination thereof.

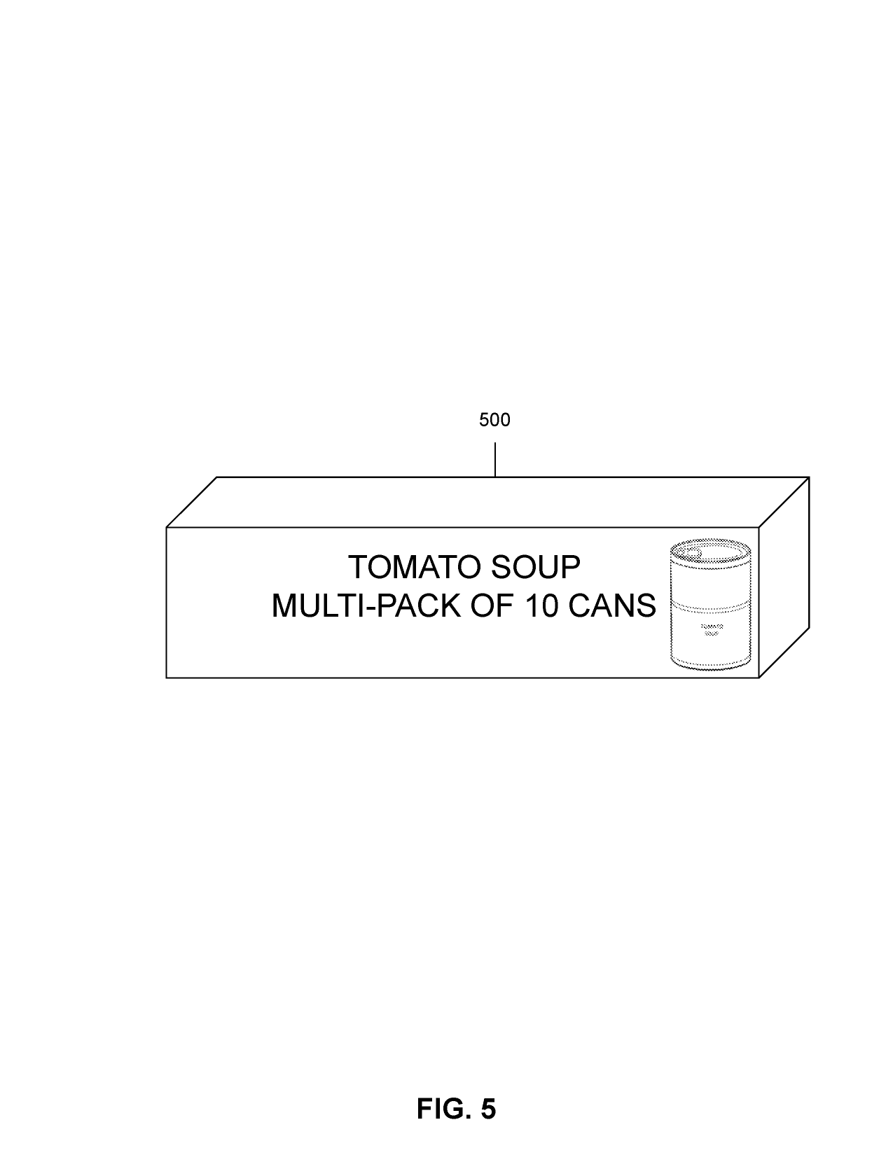

Referring now also to FIG. 5, an exemplary front perspective view secondary product packaging 500 that can be inspected by a robotic system 100 according to embodiments of the present disclosure is shown. In this example, the secondary product packaging 500 can be packaging that can contain other packaging (e.g., cans) within the secondary product packaging 500. For example, in FIG. 5, the secondary product packaging 500 can including multiple primary packaging 400 containing soup within the secondary product packaging 500. The robotic system 100 can capture media content of the secondary product packaging 500, perform a similar analysis as conducted for the primary product packaging 500, and can perform actions of the secondary product packaging 500 does not conform to specifications for the secondary product packaging 500.

Referring now also to FIG. 6, an exemplary system 600 for providing item-specific in-process inspection according to embodiments of the present disclosure is provided. Notably, the system 600 can be configured to support, but is not limited to supporting, inspection systems and services, robotic systems and services, monitoring and surveillance systems and services, alert systems and services, cloud computing systems and services, operations and supply chain systems and services, sensor applications and services, mitigation capability applications and services, firewall systems and services, data analytics systems and services, data collation and processing systems and services, artificial intelligence services and systems, machine learning services and systems, neural network services, mobile applications and services, content delivery services, satellite services, telephone services, voice-over-internet protocol services, software as a service (SaaS) applications, platform as a service (PaaS) applications, operations management applications and services, productivity applications and services, and/or any other computing applications and services. Notably, the system 600 can include a first user 601, who can utilize a first user device 602 to access data, content, and services, or to perform a variety of other tasks and functions. As an example, the first user 601 can utilize first user device 602 to transmit signals to access various services and content, such as those available on an internet, on other devices, and/or on various computing systems. In certain embodiments, the first user 601 can utilize the first user device 602 to interact and/or control a robotic system 100, cameras 130, 230, devices in a supply chain, or a combination thereof. As another example, the first user device 602 can be utilized to access an application, devices, and/or components of the system 600 that provide any or all of the operative functions of the system 600, the robotic system 100, any other devices or system of the present disclosure, or a combination thereof.

In certain embodiments, the first user 601 can be a person, a robot, a humanoid, a program, a computer, any type of user, or a combination thereof, that can be located in a particular location or environment, such as an environment including one or more robotic systems 100, robotic devices 102, cameras 130, 230, or a combination thereof. In certain embodiments, the environment or location can be associated with forming, creating, distributing, sorting, delivering, palletizing, depalletizing, induction, item picking or packing, placing and/or removing items and/or performing any other actions associated with a supply chain. In certain embodiments, the first user 601 can be a person that can want to utilize the first user device 602 to conduct various types of activities and/or control devices and systems of the system 600. For example, an activity can include, but is not limited to, controlling a robotic device or system (e.g., robotic system 100), initiating a supply chain process or task, halting a supply chain process or task, performing any other operations of the present disclosure, or a combination thereof. In certain embodiments, other activities can include, but are not limited to, accessing various types of applications, such as to perform work, control the operative functionality of the system 600, control the sensor 110, activate or deactivate cameras 130, 230, or a combination thereof.

In certain embodiments, the first user device 602 can include a memory 603 that includes instructions, and a processor 604 that executes the instructions from the memory 603 to perform the various operations that are performed by the first user device 602. In certain embodiments, the processor 604 can be hardware, software, or a combination thereof. The first user device 602 can also include an interface 605 (e.g., screen, monitor, graphical user interface, etc.) that can enable the first user 601 to interact with various applications executing on the first user device 602 and to interact with the system 600. In certain embodiments, the first user device 602 can be and/or can include a computer, any type of sensor, a laptop, a set-top-box, a tablet device, a phablet, a server, a mobile device, a smartphone, a smart watch, a voice-controlled-personal assistant, a physical monitoring device (e.g., camera, sensors, etc.), an internet of things device (IoT), appliances, an autonomous vehicle, and/or any other type of computing device. Illustratively, the first user device 602 is shown as a computer in FIG. 6. In certain embodiments, the first user device 602 can be utilized by the first user 601 to control, access, and/or provide some, or all of the operative functionality of the system 600.

In addition to using first user device 602, the first user 601 can also utilize and/or have access to any number of additional user devices. As with first user device 602, the first user 601 can utilize the additional user devices to transmit or receive signals to access various services and content and/or access functionality provided by the system 600 and/or control the robotic system 100. The additional user devices can include memories that include instructions, and processors that executes the instructions from the memories to perform the various operations that are performed by the additional user devices. In certain embodiments, the processors of the additional user devices can be hardware, software, or a combination thereof. The additional user devices can also include interfaces that can enable the first user 601 to interact with various applications executing on the additional user devices and to interact with the system 600. In certain embodiments, the first user device 602 and/or the additional user devices can be and/or can include a computer, any type of sensor, a laptop, a set-top-box, a tablet device, a phablet, a server, a mobile device, a smartphone, a smart watch, an autonomous vehicle, and/or any other type of computing device, and/or any combination thereof. Sensors can include, but are not limited to, cameras, motion sensors, acoustic/audio sensors, pressure sensors, temperature sensors, light sensors, accelerometers, gyroscopes, any type of sensors, or a combination thereof.

The first user device 602, the robotic system 100, sensor devices 110, cameras 130, 230, and/or additional user devices can belong to and/or form a communications network 633. In certain embodiments, the communications network 633 can be a local, mesh, and/or other network that enables and/or facilitates various aspects of the functionality of the system 600. In certain embodiments, the communications network can be formed between the first user device 602 and additional user devices through the use of any type of wireless or other protocol and/or technology. For example, user devices can communicate with one another in the communications network by utilizing any protocol and/or wireless technology, satellite, fiber, communication technologies (e.g., IoT, Bluetooth, Zigbee, Z-wave, Wireless HART, cellular, LoRA, NB-IoT, etc.), or any combination thereof. Notably, the communications network can be configured to communicatively link with and/or communicate with any other network of the system 600 (e.g., communications network 635) and/or outside the system 600.

In certain embodiments, the first user device 602, the robotic systems 100, the sensor devices 110, cameras 130, 230, and additional user devices belonging to the communications network 633 can share and exchange data with each other via the communications network 633. For example, the user devices can share information relating to the various components of the devices, information associated with images, links, and/or content accessed and/or attempting to be accessed by the first user 601 of the user devices, information identifying the locations of the devices, media content captured by the cameras 130, 230, information indicating a comparison of the media content to predefined specifications for packages and/or items, information indicating whether a particular package conforms to the specifications, information identifying the types of packages, information identifying the current stage of the supply chain, information identifying tasks being performed by robotic systems 100, information associated with the robotic systems 100, information indicating the types of sensors that are contained in and/or on the devices, information identifying the applications being utilized on the devices, information identifying how the devices are being utilized, information identifying user profiles for users of the devices, information identifying device profiles for the devices, information identifying the number of devices in the communications network 633, information identifying devices being added to or removed from the communications network 633, any other information, or any combination thereof.

In addition to the first user 601, the system 600 can also include a second user 621. In certain embodiments, the second user 621 can be similar to the first user 901 and can seek to access content, applications, systems, and/or devices. Additionally, the second user 621 can control the operative functionality of the robotic systems 100, control the sensor devices 110, activate components and/or devices to respond to and/or perform an action in response to determining that a package does not conform to specifications, or a combination thereof, such as by utilizing the second user device 622. In certain embodiments, the second user device 622 can be utilized by the second user 621 to transmit signals to request various types of resources, content, services, and data provided by and/or accessible by communications network 635 or any other network in the system 600. In further embodiments, the second user 621 can be a robot, a computer, a vehicle (e.g., semi or fully-automated vehicle), a humanoid, an animal, any type of user, or any combination thereof. The second user device 622 can include a memory 623 that includes instructions, and a processor 624 that executes the instructions from the memory 623 to perform the various operations that are performed by the second user device 622. In certain embodiments, the processor 624 can be hardware, software, or a combination thereof. The second user device 622 can also include an interface 625 (e.g., screen, monitor, graphical user interface, etc.) that can enable the first user 601 to interact with various applications executing on the second user device 622 and, in certain embodiments, to interact with the system 600, robotic systems 100, and/or sensor devices 110. In certain embodiments, the second user device 622 can be a computer, a laptop, a set-top-box, a tablet device, a phablet, a server, a mobile device, a smartphone, a smart watch, an autonomous vehicle, and/or any other type of computing device. Illustratively, the second user device 622 is shown as a mobile device in FIG. 6. In certain embodiments, the second user device 622 can also include sensors, such as, but are not limited to, cameras, audio sensors, motion sensors, accelerometers, gyroscopes, pressure sensors, temperature sensors, light sensors, humidity sensors, any type of sensors, or a combination thereof. In certain embodiments, the second user 621 can also utilize additional user devices as well.

In certain embodiments, the second user device 622, robotic systems 100, sensor devices 110, cameras 130, 230 and additional user devices belonging to the communications network 634 can share and exchange data with each other via the communications network 634. For example, the user devices can share information associated with packages, information identifying whether a package conforms to specifications specified for the package, media content captured of packages and/or items, information relating to the various components of the devices, information associated with images, links, and/or content accessed and/or attempting to be accessed by the second user 621 of the devices, information identifying the locations of the devices, information indicating the types of sensors that are contained in and/or on the devices, information identifying the applications being utilized on the devices, information identifying how the user devices are being utilized, information identifying user profiles for users of the devices, information identifying device profiles for the devices, information identifying the number of devices in the communications network 634, information identifying devices being added to or removed from the communications network 634, any other information, or any combination thereof.

In certain embodiments, the devices described herein can have any number of software functions, applications and/or application services stored and/or accessible thereon. For example, the user devices can include applications for controlling and/or accessing the operative features and functionality of the system 600, applications for controlling and/or accessing any device of the system 600, applications for controlling stages of a supply chain, applications for controlling robotic systems 100, artificial intelligence and/or machine learning applications, cloud-based applications, electric and/or mechanical machine health condition detection applications, electric machine health condition mitigation applications, communication applications, business applications, e-commerce applications, media streaming applications, content-based applications, media applications, database applications, gaming applications, internet-based applications, browser applications, mobile applications, service-based applications, productivity applications, video applications, music applications, social media applications, any other type of applications, any types of application services, or a combination thereof. In certain embodiments, the software applications can support the functionality provided by the system 600 and methods described in the present disclosure. In certain embodiments, the software applications and services can include one or more graphical user interfaces so as to enable the first and/or second users 601, 621 to readily interact with the software applications. The software applications and services can also be utilized by the first and/or second users 601, 621 to interact with any device in the system 600, any network in the system 600, or any combination thereof. In certain embodiments, devices can include associated telephone numbers, device identities, network identifiers (e.g., IP addresses, etc.), and/or any other identifiers to uniquely identify the user devices. In certain embodiments the software can be open-source and users 601 and 621 may be able to create their own software.

The system 600 can also include a communications network 635. The communications network 635 can include resources (e.g., data, web pages, content, documents, computing resources, applications, and/or any other resources) that can be accessible to the first user 601, second user 621, and/or any of the devices in the system 600, such as the robotic systems 100, sensor devices 110, cameras 130, 230, and/or nay other devices of the present disclosure. The communications network 635 of the system 600 can be configured to link any number of the devices in the system 600 to one another. For example, the communications network 635 can be utilized by the second user device 622 to connect with other devices within or outside communications network 635. Additionally, the communications network 635 can be configured to transmit, generate, and receive any information and data traversing the system 600. In certain embodiments, the communications network 635 can include any number of servers, databases, or other componentry. The communications network 635 can also include and be connected to a neural network, a mesh network, a local network, a cloud-computing system or network, an IMS network, a VoIP network, a security network, a VoLTE network, a wireless network, an Ethernet network, a satellite network, a broadband network, a cellular network, a private network, a cable network, the Internet, an internet protocol network, MPLS network, a content distribution network, any network, or any combination thereof. Illustratively, servers 640, 645, and 650 are shown as being included within communications network 635. In certain embodiments, the communications network 635 can be part of a single autonomous system that is located in a particular geographic region, or be part of multiple autonomous systems that span several geographic regions.

Notably, the functionality of the system 600 can be supported and executed by using any combination of the servers 640, 645, 650, and 660. The servers 640, 645, and 650 can reside in communications network 635, however, in certain embodiments, the servers 640, 645, 650 can reside outside communications network 635. The servers 640, 645, and 650 can provide and serve as a service that performs the various operations and functions provided by the system 600. In certain embodiments, the server 640 can include a memory 641 that includes instructions, and a processor 642 that executes the instructions from the memory 641 to perform various operations that are performed by the server 640. The processor 642 can be hardware, software, or a combination thereof. Similarly, the server 645 can include a memory 646 that includes instructions, and a processor 647 that executes the instructions from the memory 646 to perform the various operations that are performed by the server 645. Furthermore, the server 650 can include a memory 651 that includes instructions, and a processor 652 that executes the instructions from the memory 651 to perform the various operations that are performed by the server 650. In certain embodiments, the servers 640, 645, 650, and 660 can be network servers, routers, gateways, switches, media distribution hubs, signal transfer points, service control points, service switching points, firewalls, routers, edge devices, nodes, computers, mobile devices, or any other suitable computing device, or any combination thereof. In certain embodiments, the servers 640, 645, 650 can be communicatively linked to the communications network 635, any network, any device in the system 600, or any combination thereof.

The database 655 of the system 600 can be utilized to store and relay information that traverses the system 600, cache content that traverses the system 600, store data about each of the devices in the system 600 and perform any other typical functions of a database. In certain embodiments, the database 655 can be connected to or reside within the communications network 635, any other network, or a combination thereof. In certain embodiments, the database 655 can serve as a central repository for any information associated with any of the devices and information associated with the system 600. Furthermore, the database 655 can include a processor and memory or can be connected to a processor and memory to perform the various operations associated with the database 655. In certain embodiments, the database 655 can be connected to the servers 640, 645, 650, 660, the first user device 602, a second user device 622, the communications network 633, the communications network 934, the communications network 635, a server 640, a server 645, a server 650, a server 660, and a database 655, the additional user devices, any devices in the system 600, any process of the system 600, any program of the system 600, any other device, any network, or any combination thereof.

The database 655 can also store information and metadata obtained from the system 600, store media content captured by cameras 130, 230, store sensor data captured and/or acquired by sensors 110, store information associated with the robotic system 100 and components 104 of the robotic system 100, store specifications for packages and/or items, store baseline sensor data indicating normal package information (e.g., colors, damage, etc.), store specifications for normal operation conditions for components 104 of the robotic system 100, store information identifying possible actions to perform if media content taken of a package and/or item does not conform to specifications, store information associated with tasks being performed by the robotic systems 100, store metadata and other information associated with the first and second users 601, 621, store profiles for the networks of the system, information identifying the networks of the system 600, store configuration information for the networks and/or devices of the system 600, store user profiles associated with the first and second users 601, 621, store device profiles associated with any device in the system 600, store communications traversing the system 600, store user preferences, store information associated with any device or signal in the system 600, store information relating to patterns of usage relating to the devices, store any information obtained from any of the networks in the system 600, store historical data associated with the first and second users 601, 621, store device characteristics, store information relating to any devices associated with the first and second users 601, 621, store information associated with the communications network 635, store any information generated and/or processed by the system 600, store any of the information disclosed for any of the operations and functions disclosed for the system 600 herewith, store any information traversing the system 600, or any combination thereof. Furthermore, the database 655 can be configured to process queries sent to it by any device in the system 600.

Notably, as shown in FIG. 6, the system 600 can perform any of the operative functions disclosed herein by utilizing the processing capabilities of server 660, the storage capacity of the database 655, or any other component of the system 600 to perform the operative functions disclosed herein. The server 660 can include one or more processors 662 that can be configured to process any of the various functions of the system 600. The processors 662 can be software, hardware, or a combination of hardware and software. Additionally, the server 660 can also include a memory 661, which stores instructions that the processors 662 can execute to perform various operations of the system 600. For example, the server 660 can assist in processing processes and/or loads handled by the various devices in the system 600, such as, but not limited to, performing one or more tasks, such as tasks during a stage in a supply chain; causing one or more cameras to capture media content and/or sensor to capture sensor data; identifying packages and/or items, such as based on the media content; comparing the media content taken of the package to one or more specifications defined for the package to generate a comparison; identifying packages based on media content, codes (e.g., quick response codes, barcodes, etc.), and the like; comparing the media content captured of a package to one or more specifications defined for the package to generate a comparison; determining whether the package conforms to the specifications; performing actions associated with the package if the package does not conform to the specifications; performing additional tasks; and/or performing any other operations of the system 600; and performing any other suitable operations conducted in the system 600 or otherwise. In certain embodiments, multiple servers 660 can be utilized to process the functions of the system 600. The server 660 and other devices in the system 600, can utilize the database 655 for storing data about the devices in the system 600 or any other information that is associated with the system 600. In one embodiment, multiple databases 955 can be utilized to store data in the system 600.

In certain embodiments, the system 600 can be utilized by the robotic systems 100, the sensor devices 110, and/or other components of the system 600 to interact with each other and share information with each other. In certain embodiments, for example, the sensor data from each of the sensor devices 110 can be aggregated in the communications network 635 and can be analyzed to determine trends in the sensor data among multiple robotic systems 100, such as whether certain packages have certain types of nonconformities with specifications, whether certain packages have superior resistance to damage, whether certain packages have better labels, and/or any other information that can be affected or measurable via the sensor data, or a combination thereof. In certain embodiments, the sensor devices 110 of each robotic system 100 can form a communication network with other sensor devices 110 of other robotic systems 100. In certain embodiments, the system 600 can also be configured to assist with the performance of any of the operations and/or functionality described herein and can also be utilized to execute the method 700 and other methods described in the present disclosure.

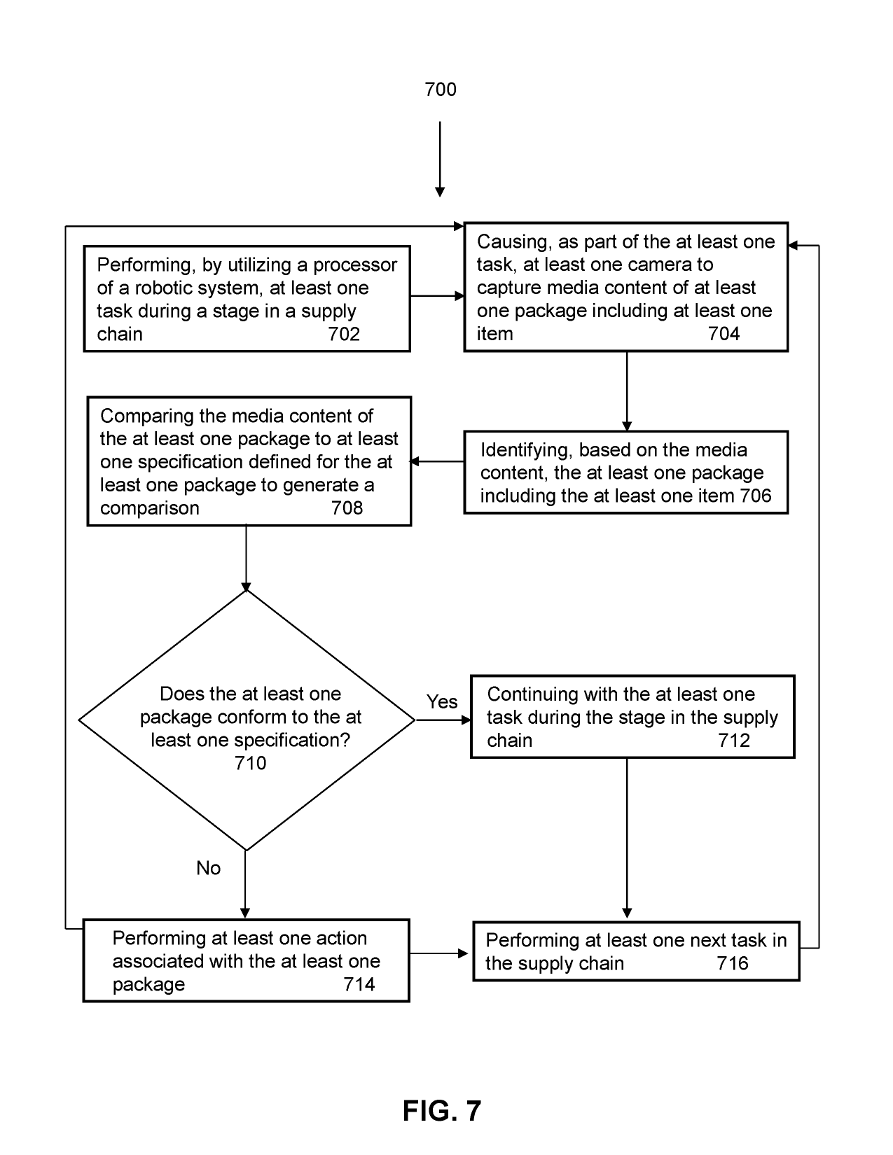

Referring now also to FIG. 7, an exemplary method 700 for providing item-specific in-process inspection according to embodiments of the present disclosure is provided. In certain embodiments, the method 700 can be implemented by utilizing the robotic system 100 and/or system 800. In certain embodiments, the method of FIG. 7 can be implemented in the system 600 of FIG. 6 and/or any other systems, devices, and/or componentry illustrated in the Figures. In certain embodiments, the method of FIG. 7 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In certain embodiments, the method of FIG. 7 can be performed at least in part by one or more processing devices (e.g., processor 642, processor 647, processor 652, and processor 662 of FIG. 6) and/or other devices, systems, components, or a combination thereof, of FIGS. 1-8. Although shown in a particular sequence or order, unless otherwise specified, the order of the operations in the method 700 can be modified and/or changed depending on implementation and objectives. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible. For example, in certain embodiments, the method 700 can be combined with other methods. In certain embodiments, a greater or fewer number of operations as illustrated in FIG. 7 can be incorporated into method 700. In certain embodiments, the method 700 can be modified to incorporate any of the functionality described in the present disclosure.

Generally, the method 700 can include operations, actions, or blocks for conducting item-specific in-process inspection according to embodiments of the present disclosure. For example, in certain embodiments, the method 700 can include utilizing a robotic system to perform various tasks, such as tasks performed during a particular stage in a supply or operations chain distributing products. As part of the task(s) that the robotic system performs, the method 700 can include causing, such as part of the task(s), one or more cameras to capture media content of

At block 702, the method 700 can include performing, such as by utilizing a processor of a robotic system (e.g., robotic system 100), one or more tasks. In certain embodiments, the one or more tasks can be tasks that are performed during a stage in a supply chain. Such stages can include, but are not limited to, palletizing, depalletizing, induction, sorting, item picking or packing, placing and/or removing items (e.g., products) from a conveyor belt or other factory equipment, forming and/or creating products, any other tasks, or a combination thereof. In certain embodiments, performing of the one or more tasks can be performed and/or facilitated by utilizing the robotic system 100, the robotic device 102, the gripper device 120, the gripper end effector 125, the system 600, any other desired components, or a combination thereof. At block 704, the method 700 can include causing one or more cameras (e.g., cameras 130) to capture media content of a package (or any number of packages) including one or more items, such as products. In certain embodiments, the media content can include audio content, image content, video content, audiovisual content, 3D content, augmented reality content, virtual reality content, sensor data (e.g., temperature data, humidity data, pressure data, vibration data, light data, acceleration data, motion data, orientation data, any type of sensor data, or a combination thereof), any type of content, or a combination thereof. In certain embodiments, the causing of the camera to capture the media content can be performed by transmitting a signal from the components of the robotic system 100 (e.g., processor 106) to the one or more cameras to activate the cameras, initiate recording, or a combination thereof. In certain embodiments, the camera can be triggered to capture the media content when a package comes within the field of view of the camera and/or a motion sensor detects the presence of a package within the field of view of the camera and triggers operation of the camera. In certain embodiments, the causing of the one or more cameras to capture media content of the package can be performed and/or facilitated by utilizing the robotic system 100, the robotic device 102, the gripper device 120, the gripper end effector 125, the system 600, any other device and/or system, or a combination thereof.

In certain embodiments, at block 704, the method 700 can include transmitting a signal (e.g., from the processor 106) to cause the gripper device 120 to secure the gripper end effector 125 to the package and the robotic device 102 of the robotic system 100 may rotate and/or move the package into various orientations and/or positions. In certain embodiments, the camera(s) 130 can be configured to capture media content that captures the package in the various orientations and/or positions. In certain embodiments, the cameras can be integrated into the robotic device 102 and/or separate from the robotic device 102, such as in a vicinity of or proximity to the robotic device 102. In certain embodiments, at block 706, the method 700 can include identifying, based on the captured media content, the package including the one or more items. In certain embodiments, the package can be identified by the camera, the robotic system 100, or a combination thereof. In certain embodiments, the identifying can be performed and/or facilitated by utilizing the robotic system 100, the robotic device 102, the gripper device 120, the gripper end effector 125, the system 600, any other device and/or system, or a combination thereof. In certain embodiments, the identification of the package can be based on the package as represented by the media content matching a pre-stored image or media content, which can be stored in memory device 108. In certain embodiments, such as if the robotic system 100 incorporates artificial intelligence and/or machine learning models, such models can perform image classification, object detection, and/or other techniques to identify the package.

At block 708, the method 700 can include comparing the media content of the package to one or more specification(s) defined for the package in order to generate a comparison of the media content to the specification(s). In certain embodiments, the specifications can include, but are not limited to, a labeling criterion (e.g., proper expiration data, shipping marks, correct logos, correct text or content on a label for the package, etc.), contamination criterion (e.g., a certain amount or allowable color of stains, a threshold amount of chemical exposure, a certain amount of contaminant on the package, etc.), location criterion (e.g., labels on the package are in a specific defined location (e.g., UPC code needs to be a certain threshold distance from the edge of a box), image content on the label or package are in the correct locations, etc.), material criterion (e.g., the package is made of the correct type of material, etc.), damage criterion (e.g., the package has either no damage, only a certain type of damage, and/or a certain amount of damage, package has dents, creases, rips, tears, etc.), color criterion (e.g., the package has the correct color(s), quality criterion (e.g., printed text on package has the correct quality level, such as size, color, pixel density, etc.), a blemish criterion (e.g., a certain amount and/or type of blemishes that can be acceptable on the package, etc.), item criterion (e.g., package has the correct items and/or number of items in the package), any type of criterion, or a combination thereof. At block 710, the method 700 can include determining if the package conforms to the specification(s) based on the comparison. In certain embodiments, the determining can be performed and/or facilitated by utilizing the robotic system 100, the robotic device 102, the system 600, any other device and/or system, or a combination thereof.

If, at block 710, it is determined that the package conforms to the specification(s) specified for the type of package, the method 700 can proceed to block 712. At block 712, the method 700 can include continuing with the tasks that is being performed by the robotic system, such as a task during a stage in a supply chain utilized to create, distribute, sort, and/or store products. In certain embodiments, the continuing with the task can be performed and/or facilitated by utilizing the robotic system 100, the robotic device 102, the gripper device 120, the gripper end effector 125, the system 600, any other desired components, or a combination thereof. In certain embodiments, the method 700 can proceed to block 716, which can include performing one or more next tasks in the stage of the supply chain or beginning a task for a next stage in the supply chain. In certain embodiments, the performing of the next task(s) can be performed and/or facilitated by utilizing the robotic system 100, the robotic device 102, the gripper device 120, the gripper end effector 125, the system 600, any other desired components, or a combination thereof.

If, however, at block 710, the package does not conform to one or more of the defined specifications, the method 700 can proceed to block 714. At block 714, the method 700 can include performing one or more actions associated with the package. For example, the action can include, but is not limited to, outputting an alert (e.g., audio alert, video alert, haptic alert, any type of sensory alert, electronic message alert, etc.) indicating that the package does not conform to the specification(s) defined for the package, removing the package (e.g., from the stage of the supply chain), and replacing the package with another comparable package conforming to the specification(s), performing a corrective action on the package such that the package conforms to the specification(s) (e.g. modifying colors, adjusting labels, adjusting items in the package, removing creases or dents, removing contaminants, reducing or removing damage, etc.), not picking and/or selecting the package and/or item (e.g., not picking for inclusion to a next stage of the supply chain process or not picking for inclusion in a pallet, etc.), or a combination thereof. For example, if a package is detected that does not conform to a specification(s), the robotic device 102 may not pick or select the package, such as if the scenario involves a conveyor that routes packages and/or items to a scrap or rework location. The robotic device 102 may not pick a non-conforming package (or item), but may select conforming packages (or items) for inclusion in the next stage of the supply chain. In certain embodiments, the performing of the one or more actions can be performed and/or facilitated by utilizing the robotic system 100, the robotic device 102, the gripper device 120, the gripper end effector 125, the system 600, any other desired components, or a combination thereof.

Once the one or more actions are performed, the method 700 can proceed to block 716, which can include performing one or more next tasks in the stage of the supply chain or beginning a task for a next stage in the supply chain. In certain embodiments, the performing of the next task(s) can be performed and/or facilitated by utilizing the robotic system 100, the robotic device 102, the gripper device 120, the gripper end effector 125, the system 600, any other desired components, or a combination thereof. In certain embodiments, the method 700 can proceed to block 704, which can include causing, as part of the next task, one or more cameras to capture media content of a package (any number of packages) including an item(s). In certain embodiments, the method 700 can the proceed to block 706, 708, 710, and so forth for each stage of the supply chain and for each package or a subset of packages. Notably, the method 700 can be utilized to inspect the items themselves and the method 700 can be adapted to conduct inspection of items, such as before they are placed into packaging.

In certain embodiments, the method 700 can be repeated as desired, which can be on a continuous basis, periodic basis, or at designated times. Notably, the method 1000 can incorporate any of the other functionality as described herein and can be adapted to support the functionality of the system 600, the robotic system 100, the cameras 130, 230, and/or other components described in the present disclosure. In certain embodiments, functionality of the method 700 can be combined with other methods and/or functionality described in the present disclosure. In certain embodiments, certain operations of the method 700 can be replaced with other functionality of the present disclosure and the sequence of operations can be adjusted as desired.

In certain embodiments, the method 700 and robotic system 100 can be further enhanced by utilizing artificial intelligence and/or machine learning models to facilitate the detections, such as by conducting image classification, convolutional neural networks, object detection, deep learning, image recognition, computer vision, and/or other techniques and technologies to perform the inspections. In certain embodiments, the inspection results can be verified by a human or another system and, based on feedback relating to whether the inspections are accurate or not, can train the machine learning models to enhance future inspections so that the inspection performance continuously improves over time.

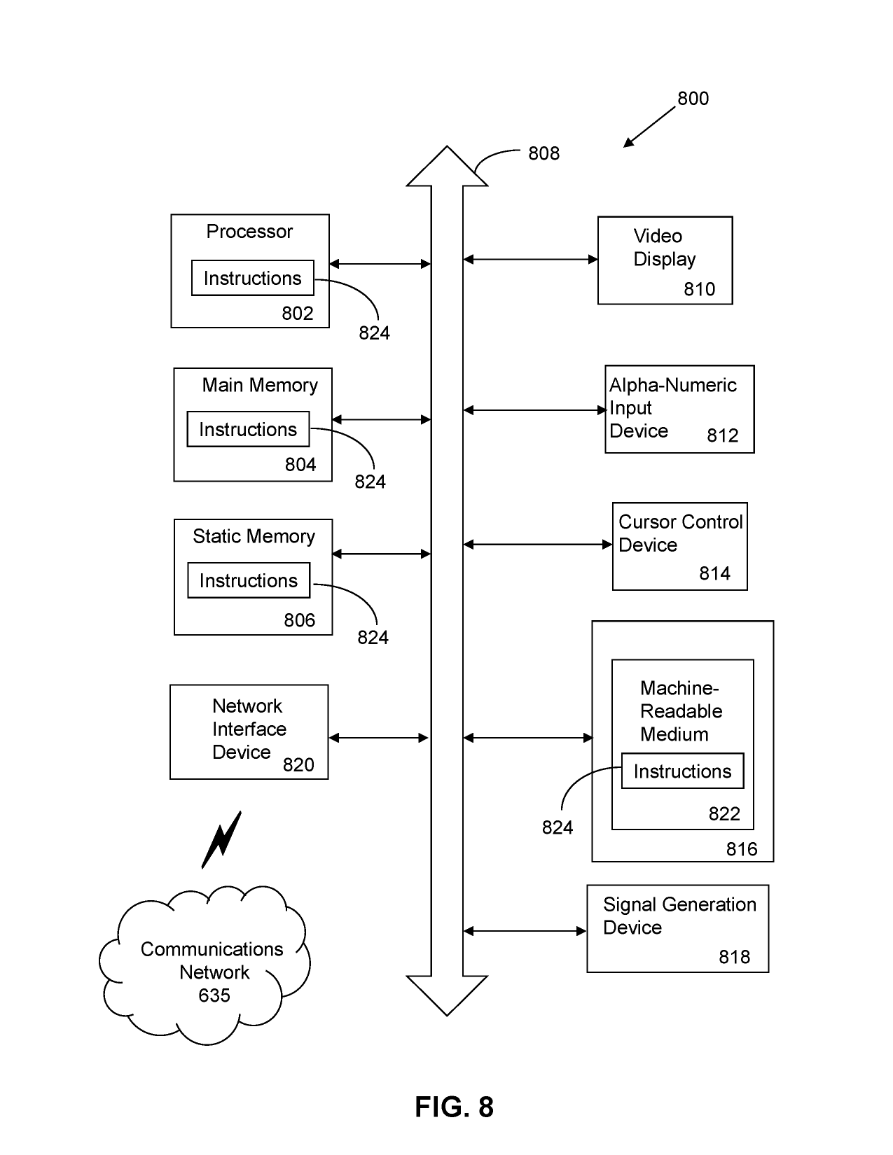

Referring now also to FIG. 8, at least a portion of the methodologies and techniques described with respect to the exemplary embodiments of the robotic system 100, the robotic device 102, the gripper device 120, the camera 230, the system 600 and/or method 700 can incorporate a machine, such as, but not limited to, computer system 800, or other computing device within which a set of instructions, when executed, can cause the machine to perform any one or more of the methodologies or functions discussed above. The machine can be configured to facilitate various operations conducted by the robotic system 100, the robotic device 102, the gripper device 120, the camera 230, the system 600, and/or method 700. For example, the machine can be configured to, but is not limited to, assist the system 600 by providing processing power to assist with processing loads experienced in the system 600, by providing storage capacity for storing instructions or data traversing the system 600, or by assisting with any other operations conducted by or within the system 600. As another example, in certain embodiments, the computer system 800 can assist in causing the robotic system 100 to perform one or more tasks with regard to packages in a supply chain; detecting packages including one or more items; capturing media content of the packages including the items; comparing the media content of the packages to specifications defined for the packages to generate a comparison; performing one or more actions associated with the packages if the comparison indicates that the package as represented by the media content does not conform to the specifications, performing any other operations, or a combination thereof.

In some embodiments, the machine can operate as a standalone device. In some embodiments, the machine can be connected (e.g., using communications network 635, another network, or a combination thereof) to and assist with operations performed by other machines and systems, such as, but not limited to, the communications network 633, the communications network 634, the communications network 635, the server 640, the server 645, the server 650, the server 660, the database 655, the robotic system 100, the robotic device 102, the gripper device 120, the camera 230, the system 600, any other system, program, and/or device, or any combination thereof. The machine can be connected with any component in the system 600. In a networked deployment, the machine can operate in the capacity of a server or a client user machine in a server-client user network environment, or as a peer machine in a peer-to-peer (or distributed) network environment. The machine can comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The computer system 800 can include a processor 802 (e.g., a central processing unit (CPU), a graphics processing unit (GPU, or both), a main memory 804 and a static memory 806, which communicate with each other via a bus 808. The computer system 800 can further include a video display unit 810, which can be, but is not limited to, a liquid crystal display (LCD), a flat panel, a solid-state display, or a cathode ray tube (CRT). The computer system 800 can include an input device 812, such as, but not limited to, a keyboard, a cursor control device 814, such as, but not limited to, a mouse, a disk drive unit 816, a signal generation device 818, such as, but not limited to, a speaker or remote control, and a network interface device 820.

The disk drive unit 816 can include a machine-readable medium 822 on which is stored one or more sets of instructions 824, such as, but not limited to, software embodying any one or more of the methodologies or functions described herein, including those methods illustrated above. The instructions 824 can also reside, completely or at least partially, within the main memory 804, the static memory 806, or within the processor 802, or a combination thereof, during execution thereof by the computer system 800. The main memory 804 and the processor 802 also can constitute machine-readable media.

Dedicated hardware implementations including, but not limited to, application specific integrated circuits, programmable logic arrays and other hardware devices can likewise be constructed to implement the methods described herein. Applications that can include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine-readable medium 822 containing instructions 824 so that a device connected to the communications network 633, the communications network 634, the communications network 635, another network, or a combination thereof, can send or receive voice, video or data, and communicate over the communications network 635, another network, or a combination thereof, using the instructions. The instructions 824 can further be transmitted or received over the communications network 633, the communications network 634, the communications network 635, another network, or a combination thereof, via the network interface device 820.

While the machine-readable medium 822 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that causes the machine to perform any one or more of the methodologies of the present disclosure.

The terms “machine-readable medium,” “machine-readable device,” or “computer-readable device” shall accordingly be taken to include, but not be limited to: memory devices, solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. The “machine-readable medium,” “machine-readable device,” or “computer-readable device” can be non-transitory, and, in certain embodiments, cannot include a wave or signal per se. Accordingly, the disclosure is considered to include any one or more of a machine-readable medium or a distribution medium, as listed herein and including art-recognized equivalents and successor media, in which the software implementations herein are stored.

The illustrations of arrangements described herein are intended to provide a general understanding of the structure of various embodiments, and they are not intended to serve as a complete description of all the elements and features of apparatus and systems that might make use of the structures described herein. Other arrangements can be utilized and derived therefrom, such that structural and logical substitutions and changes can be made without departing from the scope of this disclosure. Figures are also merely representational and cannot be drawn to scale. Certain proportions thereof can be exaggerated, while others can be minimized. Accordingly, the specification and drawings are to be regarded in an illustrative rather than a restrictive sense.

Thus, although specific arrangements have been illustrated and described herein, it should be appreciated that any arrangement calculated to achieve the same purpose can be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure is not limited to the particular arrangement(s) disclosed as the best mode contemplated for carrying out this invention, but that the invention will include all embodiments and arrangements falling within the scope of the appended claims.

The foregoing is provided for purposes of illustrating, explaining, and describing embodiments of this invention. Modifications and adaptations to these embodiments will be apparent to those skilled in the art and can be made without departing from the scope or spirit of this invention. Upon reviewing the aforementioned embodiments, it would be evident to an artisan with ordinary skill in the art that said embodiments can be modified, reduced, or enhanced without departing from the scope and spirit of the claims described below.

At least some aspects of the present disclosure will now be described with reference to the following numbered clauses.

Clause 1: A system, may include; a robotic device that can be configured to perform at least one task; at least one camera that can be configured to capture media content; and at least one processor configured to: cause the robotic device to perform the at least one task during a stage in a supply chain; detect, by utilizing the at least one camera and as part of the at least one task, at least one package, at least one item, or a combination thereof; cause the at least one camera to capture media content of the at least one package, the at least one item, or a combination thereof; compare the media content of the at least one package, the at least one item, or a combination thereof, to at least one specification defined for the at least one package, the at least one item, or a combination thereof, to generate a comparison; and perform at least one action associated with the at least one package, the at least one item, or a combination thereof, if the comparison indicates that the at least one package, the at least one item, or a combination thereof, as represented by the media content does not conform to the at least one specification defined for the at least one package, the at least one item, or a combination thereof.

Clause 2: The system of clause 1, wherein the robotic device further comprises: a gripper device configured to secure the at least one package, the at least one item, or a combination thereof, to the robotic device.

Clause 3: The system of clause 1 or 2, wherein the at least one processor is further configured to: cause the gripper device to secure to the at least one package, the at least one item, or a combination thereof, to the robotic device after the at least one, the at least one item, or a combination thereof.

Clause 4: The system of clause 1, 2, or 3, wherein the at least one processor is further configured to: cause the gripper device to release the at least one package, the at least one item, or a combination thereof, from the robotic device if the comparison indicates that the at least one package, the at least one item, or a combination thereof, as represented by the media content conforms to the at least one specification defined for the at least one package, the at least one item, or a combination thereof.

Clause 5: The system of clause 1, 2, 3, or 4, wherein the at least one processor is further configured to: identify the at least one package, the at least one item, or a combination thereof, based on the media content.

Clause 6: The system of clause 1, 2, 3, 4, or 5, wherein the system further comprises at least one sensor configured to: acquire sensor data associated with the at least one package, the at least one item, or a combination thereof; provide the sensor data to the at least one processor; and generate the comparison using the sensor data.

Clause 7: The system of clause 1, 2, 3, 4, 5, or 6, wherein the system further comprises at least one memory device configured to: store the at least one specification for the at least one package, the at least one item, or a combination thereof,; and store the comparison generated based on comparing the media content to the at least one specification.

Clause 8: The system of clause 1, 2, 3, 4, 5, 6, or 7, wherein the at least one processor is further configured to: cause the robotic device to adjust an orientation or position of the at least one package, the at least one item, or a combination thereof; and cause the at least one camera to capture the media content of the at least one package, the at least one item, or a combination thereof, while in the orientation.

Clause 9: The system of clause 1, 2, 3, 4, 5, 6, 7, or 8, wherein the at least one processor is further configured to: modify the at least one specification for the at least one package, the at least one item, or a combination thereof, to generate at least one modified specification; and compare the media content of the at least one package to the at least one modified specification defined for the at least one package, the at least one item, or a combination thereof,.

Clause 10: The system of clause 1, 2, 3, 4, 5, 6, 7, 8, or 9, wherein the at least one processor is further configured to: detect, by utilizing the at least one camera and as part of the at least one task, at least one other package, at least one other item, or a combination thereof; cause the at least one camera to capture other media content of the at least one other package, the at least one other item, or a combination thereof; and compare the media content of the at least one other package, the at least one other item, or a combination thereof, to at least one different specification defined for the at least one other package, the at least one other item, or a combination thereof.

Clause 11: The system of clause 1, 2, 3, 4, 5, 6, 7, 8, 9, or 10, wherein the at least one processor is configured to: perform the at least one action associated with the at least one package, the at least one item, or a combination thereof, if the comparison indicates that the at least one package, the at least one item, or a combination thereof, as represented by the media content does not conform to the at least one specification defined for the at least one package, the at least one item, or a combination thereof, wherein the at least one action comprises at least one of: output an alert indicating that the at least one package, the at least one item, or a combination thereof, does not conform to the at least one specification defined for the at least one package, the at least one item, or a combination thereof; remove the at least one package, the at least one item, or a combination thereof,; and/or replace the at least one package, the at least one item, or a combination thereof, with at least one other package, at least one other item, or a combination thereof, conforming to the at least one specification.

Clause 12: A method, may include: performing, by utilizing a processor of a robotic system, at least one task during a stage in a supply chain; causing, as part of the at least one task and by utilizing the processor, at least one camera to capture media content of at least one package, the at least one item, or a combination thereof; identifying, based on the media content and by utilizing the processor, the at least one package, the at least one item, or a combination thereof; comparing, by utilizing the processor, the media content of the at least one package, the at least one item, or a combination thereof, to at least one specification defined for the at least one package, the at least one item, or a combination thereof, to generate a comparison; and performing, by utilizing the processor, at least one action associated with the at least one package, the at least one item, or a combination thereof, if the comparison indicates that the at least one package as represented by the media content does not conform to the at least one specification defined for the at least one package, the at least one item, or a combination thereof.

Clause 13: The method of clause 12, further comprising activating a gripper device of the robotic system to secure the at least one package, the at least one item, or a combination thereof, to the robotic system.

Clause 14: The method of clause 12 or 13, adjusting, by utilizing the gripper device, at least one position of the at least one package, at least one orientation of the at least one package, at least one position of the item, at least one orientation of the item, or a combination thereof; and capturing, by utilizing the camera device, the media content of the at least one package, the at least one item, or a combination thereof, in the at least one position, in the at least one orientation, or a combination thereof.

Clause 15: The method of clause 12, 13, or 14, wherein performing the at least one action comprises: outputting an alert indicating that the at least one package does not conform to the at least one specification defined for the at least one package, the at least one item, or a combination thereof; removing the at least one package, the at least one item, or a combination thereof; replacing the at least one package with at least one other package and/or at least one other item conforming to the at least one specification, or a combination thereof.

Clause 16: The method of clause 12, 13, 14, or 15, further comprising setting the at least one specification for the at least one package, the at least one item, or a combination thereof, based on a type of the at least one package, based on a type of the at least one item, based on a quality standard, based on a labeling standard, or a combination thereof.

Clause 17: The method of clause 12, 13, 14, 15, or 16, wherein the at least one package comprises a primary package, a secondary package, or a combination thereof.

Clause 18: The method of clause 12, 13, 14, 15, 16, or 17, wherein the at least one specification comprises a labeling specification, a contamination specification, a label location, a package damage specification, an expiration date, a color specification, a print quality specification, a packaging specification, or a combination thereof.

Clause 19: The method of clause 12, 13, 14, 15, 16, 17, or 18, further comprising: a capturing sensor data from at least one sensor configured to capture the sensor data associated with the at least one package, the at least one item, or a combination thereof; and generating the comparison using the media content and the sensor data.

Clause 20: A robotic device, may include: at least one camera configured to capture media content; and at least one processor configured to: perform at least one task during a stage in a supply chain; cause, as part of the at least one task, the at least one camera to capture media content of at least one package, the at least one item, or a combination thereof; identify, based on the media content, the at least one package, the at least one item, or a combination thereof; compare the media content of the at least one package, the at least one item, or a combination thereof, to at least one specification defined for the at least one package, the at least one item, or a combination thereof, to generate a comparison; and perform at least one action associated with the at least one package, the at least one item, or a combination thereof, if the comparison indicates that the at least one package, the at least one item, or a combination thereof, as represented by the media content does not conform to the at least one specification defined for the at least one package, the at least one item, or a combination thereof.

What is claimed is:

1. A system, comprising:
a robotic device configured to perform at least one task;
at least one camera configured to capture media content; and
at least one processor configured to:
cause the robotic device to perform the at least one task during a stage in a supply chain;
detect, by utilizing the at least one camera and as part of the at least one task, at least one package, at least one item, or a combination thereof;
cause the at least one camera to capture media content of the at least one package, the at least one item, or a combination thereof;
compare the media content of the at least one package, the at least one item, or a combination thereof, to at least one specification defined for the at least one package, the at least one item, or a combination thereof, to generate a comparison; and
perform at least one action associated with the at least one package, the at least one item, or a combination thereof, if the comparison indicates that the at least one package, the at least one item, or a combination thereof, as represented by the media content does not conform to the at least one specification defined for the at least one package, the at least one item, or a combination thereof.

2. The system of claim 1, wherein the robotic device further comprises:
a gripper device configured to secure the at least one package, the at least one item, or a combination thereof, to the robotic device.

3. The system of claim 2, wherein the at least one processor is further configured to:
cause the gripper device to secure to the at least one package, the at least one item, or a combination thereof, to the robotic device after the at least one package, the at least one item, or a combination thereof, is detected.

4. The system of claim 3, wherein the at least one processor is further configured to:
cause the gripper device to release the at least one package, the at least one item, or a combination thereof, from the robotic device if the comparison indicates that the at least one package, the at least one item, or a combination thereof, as represented by the media content conforms to the at least one specification defined for the at least one package, the at least one item, or a combination thereof.

5. The system of claim 1 , wherein the at least one processor is further configured to:
identify the at least one package, the at least one item, or a combination thereof, based on the media content.

6. The system of claim 1, wherein the system further comprises:
at least one sensor configured to:
acquire sensor data associated with the at least one package, the at least one item, or a combination thereof;
provide the sensor data to the at least one processor; and
generate the comparison using the sensor data.

7. The system of claim 1, wherein the system further comprises:
at least one memory device configured to:
store the at least one specification for the at least one package, the at least one item, or a combination thereof; and
store the comparison generated based on comparing the media content to the at least one specification.

8. The system of claim 1, wherein the at least one processor is further configured to:
cause the robotic device to adjust an orientation or a position of the at least one package, the at least one item, or a combination thereof; and
cause the at least one camera to capture the media content of the at least one package while in the orientation or the position.

9. The system of claim 1, wherein the at least one processor is further configured to:
modify the at least one specification for the at least one package, the at least one item, or a combination thereof, to generate at least one modified specification; and
compare the media content of the at least one package, the at least one item, or a combination thereof, to the at least one modified specification defined for the at least one package, the at least one item, or a combination thereof,.

10. The system of claim 1, wherein the at least one processor is further configured to:
detect, by utilizing the at least one camera and as part of the at least one task, at least one other package, at least one other item, or a combination thereof;
cause the at least one camera to capture other media content of the at least one other package, the at least one other item, or a combination thereof; and
compare the media content of the at least one other package, the at least one other item, or a combination thereof, to at least one different specification defined for the at least one other package, the at least one other item, or a combination thereof.

11. The system of claim 1, wherein the at least one processor is configured to:
perform the at least one action associated with the at least one package, the at least one item, or a combination thereof, if the comparison indicates that the at least one package, the at least one item, or a combination thereof, as represented by the media content does not conform to the at least one specification defined for the at least one package, the at least one item, or a combination thereof, wherein the at least one action comprises at least one of:
output an alert indicating that the at least one package, the at least one item, or a combination thereof, does not conform to the at least one specification defined for the at least one package, the at least one item, or a combination thereof;
remove the at least one package, the at least one item, or a combination thereof; or
replace the at least one package, the at least one item, or a combination thereof, with at least one other package, at least one other item, or a combination thereof, conforming to the at least one specification.

12. A method, comprising:
performing, by utilizing a processor of a robotic system, at least one task during a stage in a supply chain;
causing, as part of the at least one task and by utilizing the processor, at least one camera to capture media content of at least one package, at least one item, or a combination thereof;
identifying, based on the media content and by utilizing the processor, the at least one package, the at least one item, or a combination thereof;
comparing, by utilizing the processor, the media content of the at least one package, the at least one item, or a combination thereof, to at least one specification defined for the at least one package, the at least one item, or a combination thereof, to generate a comparison; and
performing, by utilizing the processor, at least one action associated with the at least one package, the at least one item, or a combination thereof, if the comparison indicates that the at least one package, the at least one item, or a combination thereof, as represented by the media content does not conform to the at least one specification defined for the at least one package, the at least one item, or a combination thereof.

13. The method of claim 12, further comprising activating a gripper device of the robotic system to secure the at least one package, the at least one item, or a combination thereof, to the robotic system.

14. The method of claim 13, further comprising:
adjusting, by utilizing the gripper device, at least one position of the at least one package, at least one orientation of the at least one package, at least one position of the at least one item, at least one orientation of the at least one item, or a combination thereof; and
capturing, by utilizing the at least one camera device, the media content of the at least one package or the at least one item in the at least one position, in the at least one orientation, or a combination thereof.

15. The method of claim 12, wherein performing the at least one action comprises:
outputting an alert indicating that the at least one package, the at least one item, or a combination thereof, does not conform to the at least one specification defined for the at least one package, the at least one item, or a combination thereof;
removing the at least one package, the at least one item, or a combination thereof; or
replacing the at least one package, the at least one item, or a combination thereof, with at least one other package, at least one other item, or a combination thereof, conforming to the at least one specification.

16. The method of claim 12, further comprising setting the at least one specification for the at least one package, the at least one item, or a combination thereof, based on a type of the at least one package, based on a type of the at least one item, based on a quality standard, based on a labeling standard, or a combination thereof.

17. The method of claim 12, wherein the at least one package comprises a primary package, a secondary package, or a combination thereof.

18. The method of claim 12, wherein the at least one specification comprises a labeling specification, a contamination specification, a label location, a package damage specification, an expiration date, a color specification, a print quality specification, a packaging specification, or a combination thereof.

19. The method of claim 12, further comprising:
capturing sensor data from at least one sensor configured to capture the sensor data associated with the at least one package, the at least one item, or a combination thereof; and
generating the comparison using the media content and the sensor data.

20. A robotic device, comprising:
at least one camera configured to capture media content; and
at least one processor configured to:
perform at least one task during a stage in a supply chain;
cause, as part of the at least one task, the at least one camera to capture media content of at least one package, at least one item, or a combination thereof,;
identify, based on the media content, the at least one package, the at least one item, or a combination thereof, including the at least one item;
compare the media content of the at least one package, the at least one item, or a combination thereof, to at least one specification defined for the at least one package, the at least one item, or a combination thereof, to generate a comparison; and
perform at least one action associated with the at least one package, the at least one item, or a combination thereof, if the comparison indicates that the at least one package, the at least one item, or a combination thereof, as represented by the media content does not conform to the at least one specification defined for the at least one package, the at least one item, or a combination thereof.
